(19) United States
(12) Patent Application Publication
(10) Pub. No.: US 2026/0025029 A1
(43) Pub. Date: Jan. 22, 2026

(54) Winding Carrier, in particular a Stator, for an Axial Flux Machine

(71) Applicant: EMIL MOTORS GMBH, Hersbruck (DE)

(72) Inventors: Maximilian Guettinger, Hersbruck (DE); Johannes Unhold, Hersbruck (DE)

(21) Appl. No.: 18/954,795

(22) Filed: Nov. 21, 2024

(30) Foreign Application Priority Data
Jul. 19, 2024 (DE) 102024120637.3

(51) Int. Cl. H02K 1/14; H02K 3/24; H02K 15/02; H02K 15/06; H02K 16/02; H02K 17/02

(52) U.S. Cl. CPC H02K 1/148; H02K 3/24; H02K 15/021; H02K 15/064; H02K 16/02; H02K 17/02; H02K 2201/12

(57) ABSTRACT

The invention relates to a winding carrier, in particular a stator, for an axial flux machine having a winding carrier yoke, from which winding carrier teeth distributed circumferentially on one or both sides in the axial direction project with interposed winding carrier grooves, in which at least one winding wire is deposited to form at least one winding, wherein the winding carrier is of segmental construction, in which a plurality of winding carrier segments are joined together annularly one behind the other in a circumferential direction, wherein at least one winding carrier segment can be fitted with the winding. The winding of the winding carrier segment is designed as a toroidal winding, in which winding wire is wound around the winding carrier yoke using a toroidal winding technique.

### CROSS-REFERENCE TO RELATED APPLICATIONS

The present application claims the benefit of German Patent Application No. 10-2024-120-637.3, filed Jul. 19, 2024, the disclosure of which is incorporated by reference.

### BACKGROUND OF THE INVENTION

The invention relates to a winding carrier, in particular a stator, for an axial flux machine. The invention also relates to a method for manufacturing such a winding carrier and to an axial flux machine with such a winding carrier.

With regard to the simple industrial production of such axial flux machines, it is known to design the stator in a segmented construction. The stator segments can be provided as individual components, for example with plastic add-on parts, and/or wound with a winding in a winding process. The stator segments can then be joined together to form the stator. The individual stator segments can be subjected to individual quality control during the manufacturing process, so that defective segments can be sorted out in a targeted and resource-saving manner, while a complete stator manufactured as a one-piece structural part would have to be completely sorted out.

However, the winding of the stator segments, which are kept as individual components, has proven to be problematic with the segment design for the following reasons: the individual stator segments often have a complex geometry and irregular shape. These irregular shapes make winding the wires more difficult and require special winding techniques and machines, which increases the production costs.

### SUMMARY OF THE INVENTION

The object of the invention is to provide a winding carrier, in particular a stator for an axial flux machine, which has a simple design and is easy to manufacture in terms of process reliability and production technology with regard to large-scale production. This object is achieved by embodiments of the invention as disclosed herein.

The invention relates to a winding carrier, in particular a stator, for an axial flux machine with an annular winding carrier yoke, from which winding carrier teeth distributed circumferentially on one or both sides project in the axial direction with interposed winding carrier grooves. Winding wires are placed in the winding carrier grooves to form windings. The winding carrier is designed in a segment construction in which a large number of winding carrier segments can be joined together in a ring shape one behind the other in a circumferential direction in an assembly process. According to the characterizing part of claim 1, each of the winding carrier segments is wound with at least one winding designed as a toroidal winding, in which the winding wire is wound around the winding carrier yoke using a toroidal winding technique.

In a technical implementation, each of the winding carrier grooves has a groove base and lateral groove flanks. The winding carrier groove is also open in the axial direction via a groove slot. The groove slot can be limited by at least one pole shoe of an adjacent winding carrier tooth that is widened in the circumferential direction, so that an undercut with an inner corner area is formed between the pole shoe and the adjoining groove flank. The pole shoe is preferably formed directly on the axial end face of the adjacent winding carrier tooth.

The winding carrier grooves can be open radially inwards and radially outwards and have parallel flanks, i.e. groove flanks parallel to one another. Alternatively and/or additionally, each of the winding carrier segments can be wedge-shaped, so that their circumferential width is reduced in a wedge shape from the outer circumference of the segment towards the inner circumference of the segment.

Each of the winding carrier segments can be wound with the toroidal winding as a separate component before assembly. Alternatively, the toroidal winding is first generated separately from the winding carrier segment and then fitted to the winding carrier segment.

In order to simplify the assembly of the winding carrier in terms of production technology, it is preferable for it to be made up of as few different components as possible. Against this background, all winding carrier segments can be of identical design. Each of the winding carrier segments can have exactly one winding carrier tooth, which merges into a segment base body at its tooth root. Viewed in the circumferential direction, the segment base body can have a contact surface on both sides, which in the assembled state is in contact with a contact surface of the segment base body of the adjacent winding carrier segment. In the assembled state, the segment base bodies of the winding carrier segments therefore form the winding carrier yoke.

Viewed in the circumferential direction, the segment base body is designed with a base body projection on at least one winding side, which projects beyond a groove flank of the winding carrier tooth by a profile height in the circumferential direction. The toroidal winding is guided in a ring around the base body projection. In the winding process, the winding wire is wound directly onto the base body projection, forming the toroidal winding. Alternatively, the toroidal winding can first be manufactured as a separate component and then placed on the base body projection. A transition step between the contact surface formed on the base body projection and the groove flank of the winding carrier tooth can form the groove base of the winding carrier tooth.

The segment side facing away from the winding side in the circumferential direction is designed as a flat side in which the contact surface and the groove flank of the winding carrier tooth merge flush with one another, i.e. form a flat segment surface overall. By providing the flat surface of the segment flat side, the processing of the winding carrier-segment can be carried out using standardized machines and processes, which reduces the need for special tools and devices. This reduces the complexity and costs of production.

The pole shoe can be formed on the flat side facing away from the winding side in the circumferential direction. The pole shoe can project from the groove flank of the winding carrier tooth by a profile height in the circumferential direction, so that in particular the winding side of the winding carrier segment is designed without a pole shoe in order to allow the winding carrier segment to be wound without interfering contours. The winding carrier segment can also be made from a laminated core with laminations that are stacked on top of each other in the winding carrier-radial direction.

Cooling the winding carrier yoke is crucial for preventing overheating, maintaining efficiency and ensuring the magnetic and mechanical properties of the machine. Accordingly, the winding carrier yoke can have at least one cooling channel that runs through the winding carrier yoke in the radial direction. The cooling channel can be integrated as a groove in one of the contact surfaces of the winding carrier segment to save installation space and reduce the number of components. When assembled, the flow cross-section of the groove can be closed by the contact surface of the adjacent winding carrier segment.

In a specific embodiment, the winding carrier is a stator of an axial flux machine, in particular an axial flux asynchronous machine. In a first embodiment, the axial flux machine can have a double-rotor design with the stator and rotors arranged axially on both sides of the stator. In this case, circumferentially distributed stator teeth with intermediate stator slots can project from the stator yoke in the axial direction on both sides.

In a second embodiment, the axial flux machine can have a double-stator design with a rotor and stators arranged axially on both sides of the rotor. In this case, stator teeth with intermediate stator grooves can project axially from the stator yoke of the respective stator on one side of the circumference in the direction of the center rotor.

### BRIEF DESCRIPTION OF THE DRAWINGS

In the following, embodiments of the invention are described with reference to the attached. In the drawings, FIGS. 1 to 11 show different views illustrating the design of an axial flux asynchronous machine according to the invention. In particular:

FIG. 1 illustrates an axial flux asynchronous machine;

FIG. 2 illustrates a section of a stator in an unwound state;

FIG. 3 illustrates a base body;

FIG. 4 illustrates a toroidal winding that is wound around a base body;

FIG. 5 illustrates a winding process for a winding wire;

FIG. 6 illustrates a further axial flux asynchronous machine;

FIG. 7 illustrates a section of a stator in an unwound state;

FIG. 8 illustrates a base body;

FIG. 9 illustrates a winding process for a winding wire;

FIG. 10 illustrates a toroidal winding wound about a base body; and

FIG. 11 illustrates a stator segment and a toroidal winding.

### DETAILED DESCRIPTION OF THE CURRENT EMBODIMENTS

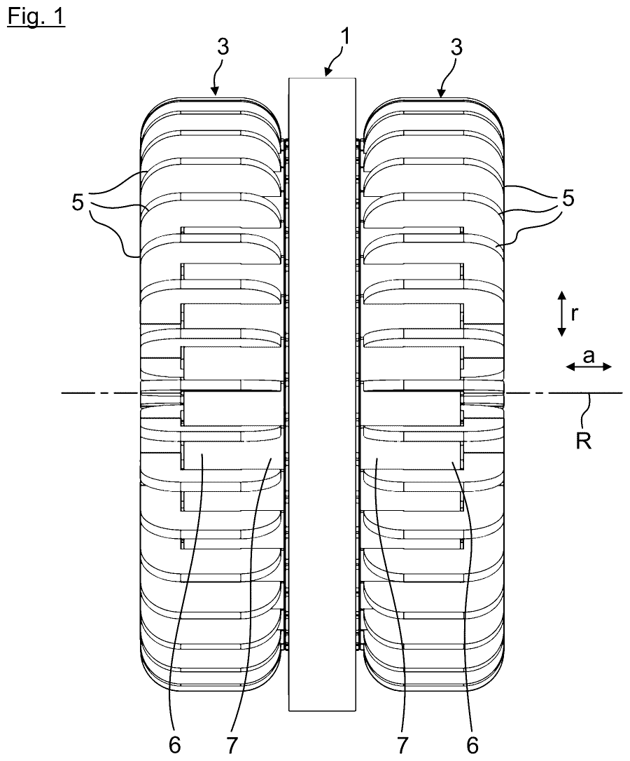

FIG. 1 shows an axial flux asynchronous machine to the extent necessary to understand the invention. Accordingly, the axial flux machine has a double-stator design, with a central rotor 1 and stators 3 arranged axially on both sides of the rotor 1. The rotor 1 and the two stators 3 are axially spaced apart by a magnetically effective air gap. Rotor 1 is a conventional asynchronous rotor. Rotor 1 therefore contains no magnetic material and can either be equipped with a classic short-circuit cage or be wound. Alternatively, the rotor 1 can also be constructed from a solid material, wherein the solid material must conduct both magnetic fields and electrical current. The solid material steel can be used as an example. Alternatively, other suitable rotor topologies can also be used.

The two stators 3 are designed with mirror symmetry in relation to a plane passing through the center of the rotor 1. The stator windings 5 are each wound as toroidal windings around the stator yoke 6 of the respective stator 3. Stator teeth 7 project axially from the stator yoke 6 in the direction of rotor 1.

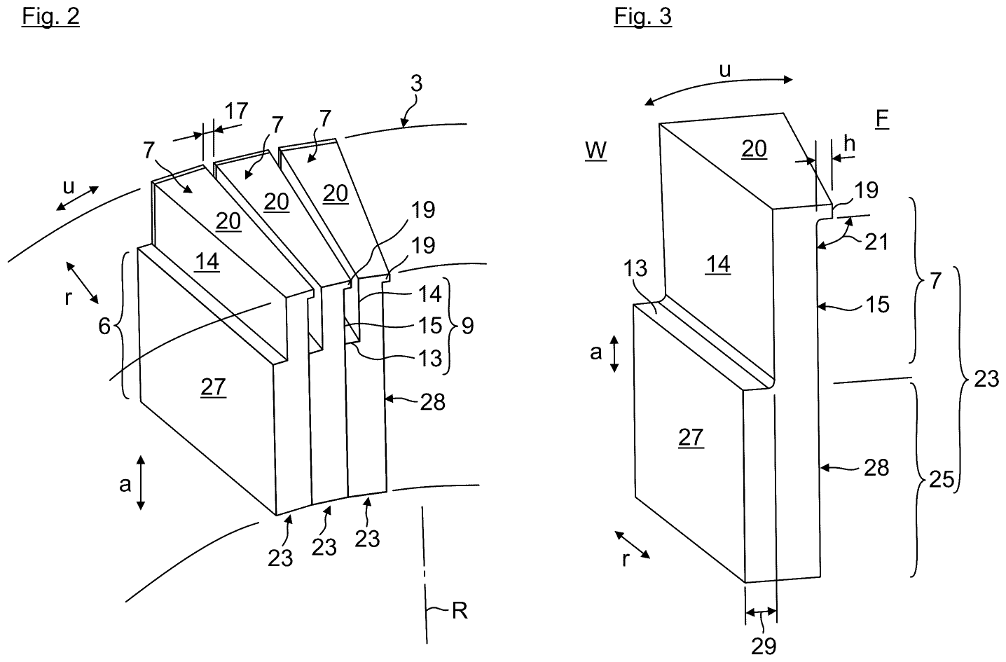

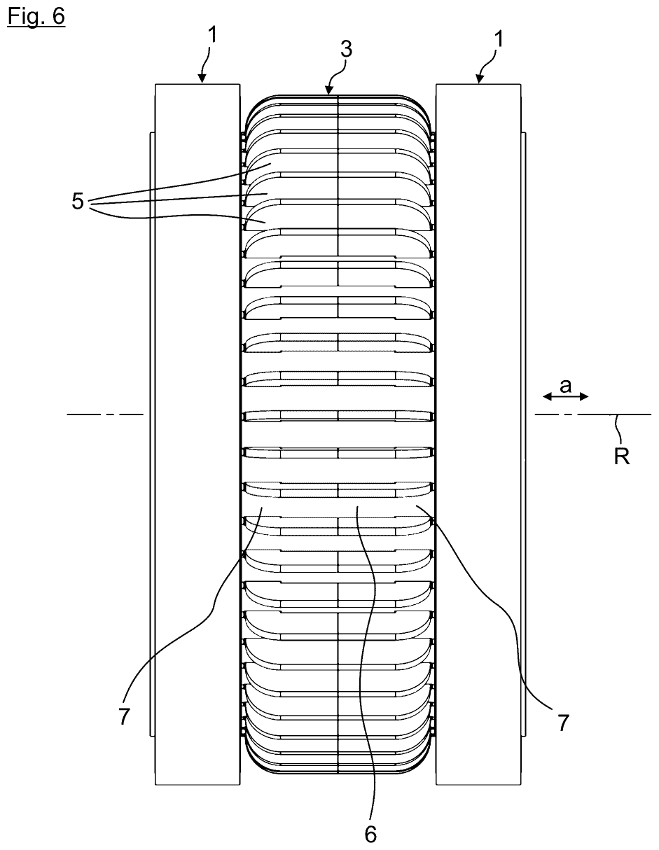

FIG. 2 shows a section of the stator 3 in the unwound state. Accordingly, the stator 3 has the circular ring-shaped stator yoke 6, from which the stator teeth 7 with intermediate stator grooves 9 project axially on one side in the direction of the rotor 1, in which winding wires 11 (FIG. 5) can be deposited to form the stator windings 5. Each of the stator slots 9 has a slot base 13 and lateral slot flanks 14, 15. In addition, each of the stator slots 9 is open in axial direction a via a slot 17 (FIG. 2). The groove slot 17 is limited by a pole shoe 19 of one of the adjacent stator teeth 7, which is widened in the circumferential direction u and is formed on its axial end face 20. This results in an undercut with an inner corner area 21 between the pole piece 19 and the adjoining groove flank 15 (FIG. 3). Each of the stator grooves 9 is open radially inwards and radially outwards and has parallel flanks, i.e. groove flanks 14, 15 parallel to one another, so that the stator teeth 7 widen outwards in a wedge shape in the radial direction r.

A core of the invention is that the unwound stator 3 is not designed as a one-piece component, but rather as a segment design in which a plurality of stator segments 23 are joined together in a ring shape one behind the other in stator-circumferential direction u. All stator segments 23 are identical in construction. In addition, each of the stator-segments 23 is made from a stack of laminations, not shown, which are stacked on top of one another in a radial direction r.

The segment geometry is explained below with reference to FIG. 3, which is designed with a view to simple industrial mass production of the stator 3. As a result, the stator segment 23 has exactly one stator tooth 7. This merges into a stator-base body 25 at its tooth root. The stator base body 25 has a contact surface 27, 28 on both sides when viewed in the circumferential direction u. In the stator assembly state, the two contact surfaces 27, 28 are in contact with a corresponding contact surface 27, 28 of the stator base body 25 of the adjacent stator segment 23. Accordingly, in the stator assembly state, the stator base bodies 25 of all stator segments 23 together form the stator yoke 6.

In FIG. 3, the segment base body 25 is formed with a base body projection 29 on one winding side W when viewed in the circumferential direction u. The base body projection 29 projects beyond a groove flank 14 of the stator tooth 7 in the circumferential direction u by a profile height. The contact surface 27 formed on the base body projection 29 merges at a transition step into the groove flank 14 of the stator tooth 7, which forms the groove base 13 of the stator tooth 7. Between the groove base 13 and the groove flank 14 there is a winding space that is open on one side, which enables the winding wire 11 to be fed in during the winding process (FIG. 5) without interfering contours and with perfect process technology.

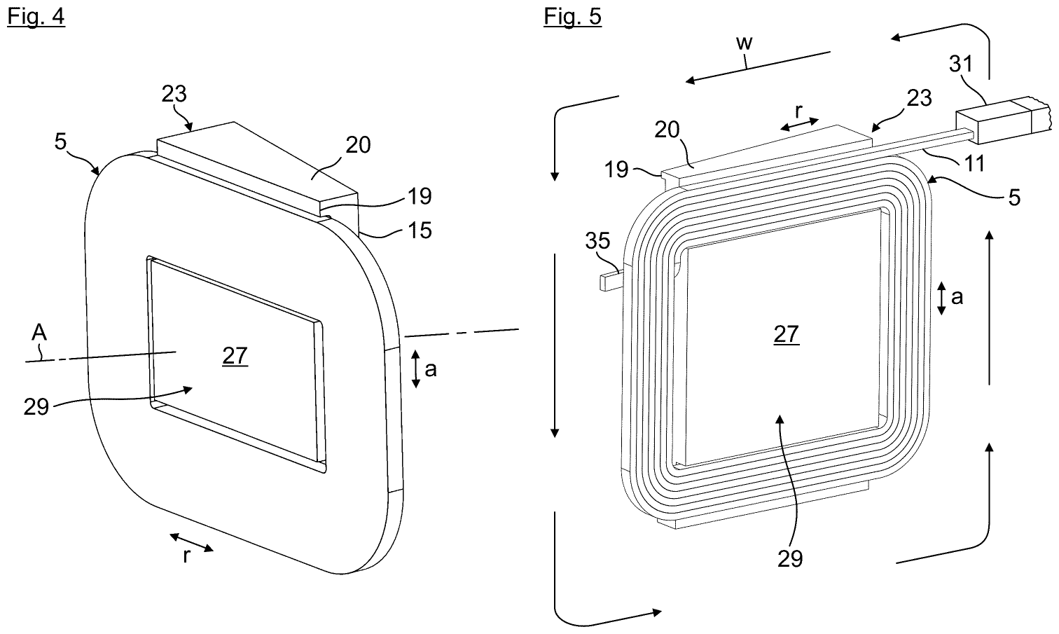

In the wound state (FIG. 4), the toroidal winding 5 is wound in a ring around the base body projection 29 around a winding axis A aligned at right angles to the contact surface 27.

In FIG. 3, the segment side facing away from the winding side W in the circumferential direction u is designed as a flat side F. On the flat side F of the stator segment 23, the contact surface 28 of the segment base body 25 and the groove flank 15 of the stator tooth 7 are flush with one another-without a transition step-resulting in a flat segment surface, which is advantageous in terms of production technology when handling the stator segment 23, compared to a segment side in which the contact surface 28 is stepped in relation to the groove flank 15.

As can also be seen in FIG. 3, the pole shoe 19 is positioned on the flat side F of the stator segment 23 facing away from the winding side W in the circumferential direction u. The pole shoe 19 formed directly on the axial end face 20 of the stator tooth 7 protrudes from the groove flank 15 by a profile height h in the circumferential direction u. In contrast, the winding side W of the stator segment 23 is designed without pole shoes to enable a winding process without interfering contours.

To ensure that the stator windings 5 are as homogeneous as possible and that the stator slot 9 to be wound is as full as possible, a flat wire with a rectangular profile is used as the winding wire 11, as shown in FIG. 5. The wire width corresponds approximately to the slot width of the stator slot 9 to be wound.

FIG. 5 roughly schematically shows a winding process in which the stator segment 23 provided as a single component is wound with the winding wire 11. The winding process takes place in a winding machine, not shown, in which the winding wire 11 exits a winding nozzle 31 under wire tension and is wound around the winding axis A (FIG. 4) onto the base body projection 29 of the stator segment 23. Due to the one-sided open winding space of the stator segment 23, a simple winding wire guide can be realized in terms of process technology, in which the winding nozzle 31 is moved in an easily controllable circular movement w (FIG. 5) around the base body projection 29, without an additional infeed movement perpendicular to the contact surface 27 of the base body projection 29. As the winding side W of the stator segment is designed without 23-pole shoes, it is easy to deposit the winding wire in the correct position and without interfering contours. In the toroidal winding 4 produced in this manner, the individual turns of winding wire 11 are laid in a single layer on top of one another in alignment, resulting in an extremely high degree of filling of the stator slot 9.

By means of the segment geometry according to the invention, precise and uniform winding is achieved in the winding process, with high repeat accuracy for all stator segments 23 of the stator 3. This ensures a uniform distribution of the magnetic flow in the stator 3, which increases the efficiency and performance of the axial flux machine.

The wound stator segment 23 is provided (before or after winding) with additional plastic add-on parts in a plastic molding procedure, with the aid of which all stator segments 23 can be joined together in an assembly process to form the stator 3. Furthermore, the winding wire ends (of which only one winding wire end 35 is shown in FIG. 5) of the toroidal windings 5 on the stator side are electrically interconnected in a manner known per se. However, it should be emphasized that the interconnection process can also take place before the assembly process. Alternatively and/or additionally, several stator segments 23 can also be wound one after the other without interrupting the winding wire.

In the previous embodiment example, each stator slot 9 is assigned exactly one toroidal winding 5. Alternatively, each of the stator slots 9 can also be assigned two toroidal windings 5, for example. In this case, there would be four winding wire ends 35 per stator slot 9, which must be connected in the wiring process.

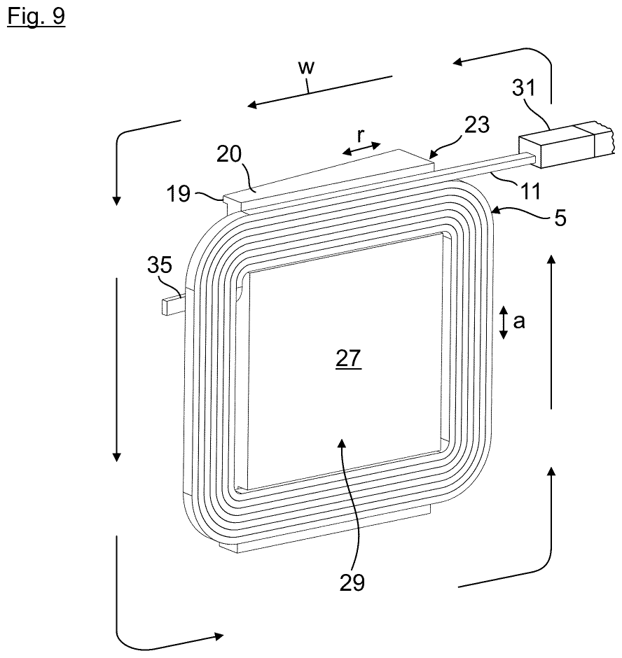

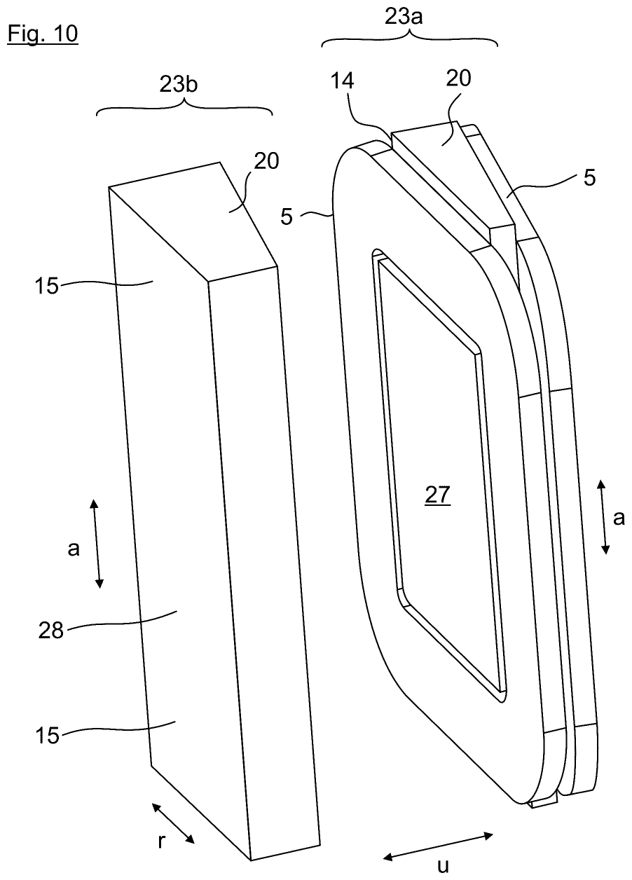

FIGS. 6 to 9 show a further design example in which the axial flux asynchronous machine is not realized in a double-stator design, but rather in a double-rotor design, namely with a stator 3 and rotors 1 arranged axially on both sides of the stator 3. The double rotor design shown in FIGS. 6 to 9 is preferable to the double stator design (FIGS. 1 to 5) in terms of increased conductor material utilization. In the double stator design, only the conductor part that lies in the stator slot 9 is used, while the entire rear side of the conductor remains unused. The double rotor design, on the other hand, makes much better use of the conductor material.

In FIG. 6, the stator windings 5 are also designed as toroidal windings, as in the previous example. The geometry of the stator 3 basically corresponds to the geometry of the stator 3 used in the double stator design, so that reference is made to the previous description. In contrast to the previous design example, circumferentially distributed stator teeth 7 with intermediate stator grooves 9 project axially on both sides of the circular stator yoke 6.

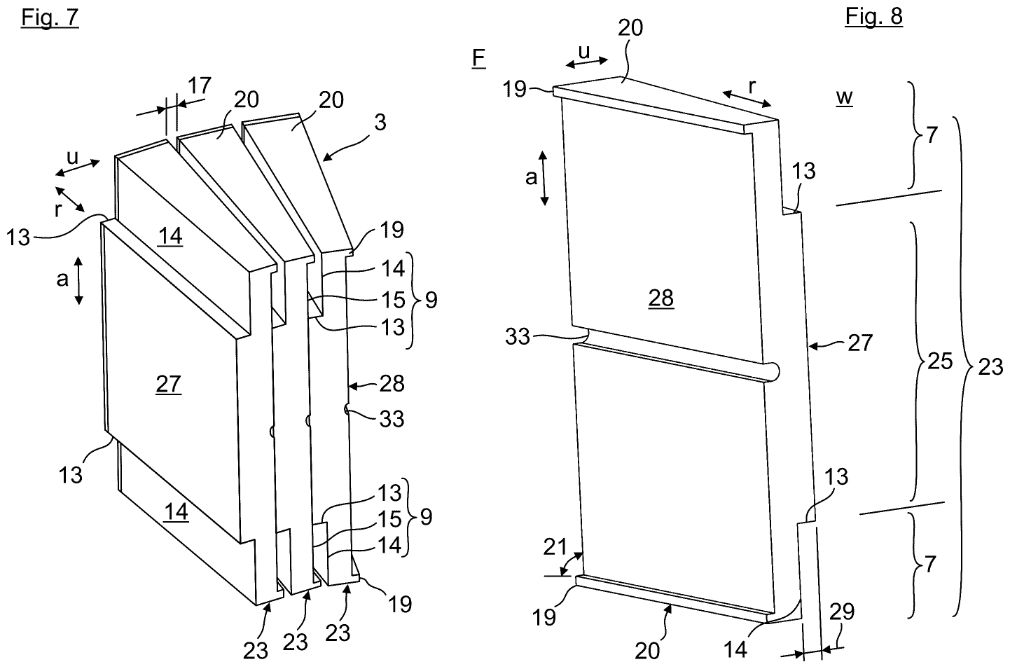

In FIGS. 7 and 8, views corresponding to FIGS. 2 and 3 show sections of an unwound stator 3 with, by way of example, three stator segments 23 arranged one behind the other and a stator segment 23 in the sole position. As a result, a stator tooth 7 is formed on both sides of the segment base body 29 when viewed in axial direction a. Each of the stator teeth 7 has a pole shoe 19 on its axial end face 20. The two pole shoes 19 each protrude in the circumferential direction u with a profile height from the flat side F of the stator segment 23.

As can also be seen from FIGS. 7 and 8, a groove 33 is incorporated in the contact surface 28 of the stator segment 23, which extends in the radial direction r over the entire contact surface 28. In the assembled state (FIG. 7), the groove cross-section is closed by the contact surface 27 of the adjacent stator segment 23. When assembled, the groove 31 acts as a cooling channel that is integrated into a coolant circuit of the axial flux machine. With the aid of the coolant-permeated cooling channel, the winding heads of the stator windings 5 in particular can be cooled effectively.

In contrast to the embodiments shown, the stator slot 14 can extend centrally through the stator tooth 7 in a comparative example not shown. In this case, the winding wire 11 would have to be guided through the circumferentially closed stator slot 15 in a substantially more complex wire guide during the winding process.

In a further comparative example not shown, the pole shoe 19 may not project from the flat side F, but from the winding side W of the stator segment 23. In this case, however, the winding process would also be more complex and subject to interfering contours.

In the embodiment example indicated in FIG. 10, two stator segments 23a, 23b are shown, which are part of a stator 3 that is designed in a double-rotor construction as in FIGS. 6 to 9. In contrast to the previous embodiment example, in FIG. 10 the stator 3 is not made of identical segments 23, but alternates with the differently designed segments 23a, 23b when viewed in the circumferential direction u, the geometry of which is described below with reference to FIG. 10: Thus, the segment 23a is basically analogous to the segments 23 of FIGS. 7 to 9, so that reference is made to their preliminary description. In contrast to FIGS. 7 to 9, the segment 23a is wound on both sides with one winding 5 each when viewed in the circumferential direction u.

Accordingly, the segment base body 25 of segment 23a is formed with a base body projection 29 on both sides when viewed in the circumferential direction u. As in FIGS. 7 and 8, each of the base body projections 29 projects beyond a slot flank 14 of the stator tooth 7 in the circumferential direction u by a profile height. The contact surface 27 formed on the respective base body projection 29 merges at a transition step into the groove flank 14 of the stator tooth 7, which forms the groove base 13 of the stator tooth 7. Between the groove base 13 and the groove flank 14, there is a winding space open on one side on each winding side W, which enables the winding wire 11 to be fed without interfering contours and with perfect process technology during the winding process.

In the wound state shown in FIG. 10, each of the toroidal windings 5 is wound in a ring around the base body projection 29 about a winding axis A aligned at right angles to the contact surface 27.

Segment 23b, on the other hand, is formed with a flat side F on both sides when viewed in the circumferential direction u. On each of the flat sides F of the stator segment 23b, the contact surface 28 of the segment base body 25 and the groove flank 15 of the stator tooth 7 are flush with one another-without a transition step-resulting in a flat segment surface on both sides.

In FIG. 10, the pole pieces 19 of the stator 3 are omitted. In order to enable a winding process without interfering contours, one can be positioned on each of the flat sides F of segment 23b, while segment 23a remains free of pole shoes.

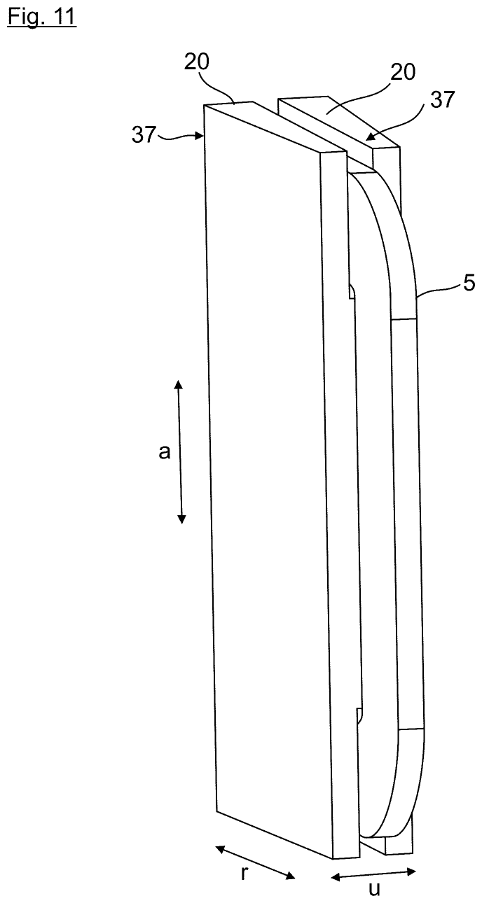

In the embodiment example indicated in FIG. 11, a stator segment 23 is shown which is also a component of a stator 3 which, as in FIGS. 6 to 9, is of a double-rotor design and is formed from a plurality of identical stator segments 23. Reference is therefore made to the previous description, which also relates to stator segments 23 in double-rotor design.

As can be seen in FIG. 11, the stator segment 23 is designed with flat sides F on both sides when viewed in the circumferential direction u. The stator segment 23 has two half-teeth 37, which are spaced apart in the circumferential direction u via a stator slot 9, which is wound with a winding 5.

In the assembled state, a plurality of such stator segments 23 are arranged one behind the other in the circumferential direction u. The stator segments 23 are in contact with one another with their flat sides F, so that two adjacent half-teeth 37 each form a stator tooth 7.

The segment geometries indicated in FIG. 10 or 11 are substantially more complex in design than the segment geometries shown in FIGS. 1 to 9. Therefore, with the segment geometries indicated in FIG. 10 or 11, standardized processing machines and/or processes are no longer readily applicable to the geometrically complex stator segment 23, 23a.

### LIST OF REFERENCE NUMERALS

1 rotor
3 stator
5 stator winding
6 stator yoke
7 stator tooth
9 stator groove
11 winding wire
13 groove base
14, 15 groove flanks
17 groove slot
19 pole shoe
20 axial face side of the stator tooth
21 inner corner area
23, 23a, 23b stator segment
25 segment base body
27, 28 contact surfaces
29 base body projection
31 winding nozzle
33 groove
35 winding wire end
37 half-teeth
a axial direction
r radial direction
u circumferential direction
W movement path of winding nozzle
A winding axis
W winding side
F flat side
R rotor axis
h profile height

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A winding carrier for an axial flux machine comprising:
a winding carrier yoke, from which winding carrier teeth are distributed circumferentially on one or both sides in an axial direction with interposed winding carrier grooves, in which at least one winding wire is deposited to form at least one winding, wherein the winding carrier is of segmented construction, wherein a plurality of winding carrier segments are joined together annularly one behind the other in a circumferential direction, wherein at least one of the plurality of winding carrier segments can be fitted with the at least one winding wire to form the at least one winding, and wherein the at least one winding wire is wound about the winding carrier yoke using a toroidal winding technique.

2. The winding carrier of claim 1, wherein each of the winding carrier grooves has a groove base and lateral groove flanks and is not open in the axial direction via a groove slot, and wherein the groove slot is bounded by at least one pole shoe of an adjacent winding carrier tooth which is widened in the circumferential direction, in such a manner that an undercut with an inner corner area is formed between the pole shoe and an adjoining groove flank.

3. The winding carrier of claim 1, wherein the winding carrier grooves are configured to open radially inwards and radially outwards with parallel flanks, and wherein each of the plurality of winding carrier segments are wedge-shaped, so that their circumferential width is reduced in a wedge shape from the outer circumference of the segment towards the inner circumference of the segment.

4. The winding carrier of claim 1, wherein each of the plurality of winding carrier segments are formed as a separate component before assembly with the toroidal winding.

5. The winding carrier of claim 1, wherein each of the plurality of winding carrier segments are of an identical design, and wherein each of the plurality of winding carrier segments has exactly one carrier tooth which merges into a base body as its tooth root, such that the base body, when viewed in the circumferential direction, has a contact surface on both sides which, in the assembled state, comes into contact with a contact surface of the base body of the adjacent winding carrier segment, so that in the assembled state the segment base bodies of the winding carrier segments form the winding carrier yoke.

6. The winding carrier of claim 5, wherein the base body, when viewed in the circumferential direction, is formed on at least one winding side with at least one base body projection, which projects beyond a groove flank of the winding carrier tooth in the circumferential direction by a profile height, such that the toroidal winding is guided annularly around the base body projection, wherein a transition step between the contact surface formed on the base body projection and the groove flank of the winding carrier tooth forms the groove base.

7. The winding carrier of claim 6, wherein:
the winding wire is wound directly onto the base body projection in a winding process, forming the toroidal winding; or
the toroidal winding is first produced as a separate component in the winding process and is then placed on the base body projection.

8. The winding carrier of claim 6, wherein at least one segment side of each the plurality of winding carrier segments is a flat side, in which the contact surface and the groove flank of the winding carrier tooth merge flush with one another.

9. The winding carrier of claim 6, wherein:
the base body is formed on both sides with a base body projection, around which a toroidal winding is guided;
the winding carrier is constructed from two groups of differently shaped winding carrier segments, such that the differently shaped winding carrier segments are arranged alternatively one behind the other as viewed in the circumferential direction in the assembled state;
the base body of each of the winding carrier segments of a first segment group is formed on both sides with a winding side, around which a toroidal winding is guided; and
the base body of each of the winding carrier segments of a second segment group is formed on both sides with a flat side, the contact surface of which is in contact with a corresponding contact surface of the winding carrier segment of the first segment group.

10. The winding carrier of claim 5, wherein each of the plurality of winding carrier segments, when viewed in the circumferential direction, is formed with flat sides on both sides, such that each of the plurality of winding carrier segments has two carrier half-teeth which are spaced apart from one another in the circumferential direction via a winding carrier groove, which is wound with the toroidal winding, such that the plurality of stator segments are arranged one behind the other in the circumferential direction, wherein the stator segments are in contact with one another with the flat sides, so that two adjacent winding carrier half-teeth each for a winding carrier tooth.

11. The winding carrier of claim 10, wherein a pole shoe is formed on a flat side surface of the winding carrier segment, such that the pole shoe projects from a groove flank of the winding carrier tooth by a profile height in the circumferential direction, so that a winding side of the winding carrier segment is free of pole shoes.

12. The winding carrier of claim 1, wherein the winding carrier yoke has a cooling channel which is guided through the winding carrier yoke in the radial direction, the cooling channel being configured as a groove in one of the contact surfaces of the winding carrier segment.

13. The winding carrier of claim 1, wherein the winding carrier is a stator of an axial flux machine, the axial flux machine having a double-rotor construction with rotors arranged axially on both sides of the stator, such that stator teeth are distributed circumferentially in the axial direction and project from a winding carrier yoke with interposed stator grooves.

14. The winding carrier of claim 1, wherein the winding carrier is a stator of an axial flux machine, the axial flux machine having a double-stator construction with stators arranged axially on both sides of a central rotor, such that stator teeth are distributed circumferentially in the axial direction and project from a winding carrier yoke towards the central rotor.

15. A method for producing a winding carrier for an axial flux machine with a winding carrier yoke, from which winding carrier teeth are distributed circumferentially in the axial direction and project with interposed winding carrier grooves, in which a winding wire is deposited to form a winding, wherein the winding carrier is of a segmented construction, wherein a plurality of winding carrier segments are joined together one behind the other in a circumferential direction, wherein at least one of the plurality of winding carrier segments are fitted with the winding, the winding being a toroidal winding, in which the winding wire is wound about the winding carrier yoke using a toroidal winding technique.

16. An axial flux asynchronous machine with the winding carrier of claim 1.
